(19) United States
(12) Patent Application Publication
(10) Pub. No.: US 2024/0419691 A1
(43) Pub. Date: Dec. 19, 2024

(54) METHODS AND APPARATUS FOR KEYWORD ASSIGNMENT PREDICTIVE INTELLIGENCE MODELING

(71) Applicant: ReverseAds Pet. Ltd., Singapore (SG)

(72) Inventors: Michael Richard HAHN, Phuket (TH); Giacomo COLAIANNI, Muang Phuket (TH); Nayana HETTIARACHCHI, Colombo (LK)

(73) Assignee: ReverseAds Pte. Ltd., Singapore (SG)

(21) Appl. No.: 18/619,854

(22) Filed: Mar. 28, 2024

Related U.S. Application Data
(63) Continuation-in-part of application No. 18/335,029, filed on Jun. 14, 2023.

(51) Int. Cl. G06F 16/28; G06N 5/022; G06Q 40/00

(52) U.S. Cl. CPC G06F 16/285; G06N 5/022; G06Q 40/00

(57) ABSTRACT

In various implementations, a keyword assignment and predictive intelligence model obtains activity data including weblog data of user devices corresponding to multiple user identifiers. The activity data and device data associated with the user devices are analyzed to generate a set of user identifier keywords for each of the user devices. The user identifiers are stack ranked according to the corresponding sets of user identifier keywords and the activity data is continuously analyzed to update the stack ranking of the user identifiers. The user identifiers are categorized according to the stack ranking such that at least a subset of the user identifiers are assigned to one or more categories and associated with one or more characteristics and/or metrics.

### CROSS-REFERENCE TO RELATED APPLICATIONS

This application is a Continuation-in-Part of U.S. patent application Ser. No. 18/335,029, entitled “METHODS AND APPARATUS FOR KEYWORD ASSIGNMENT PREDICTIVE INTELLIGENCE MODELING”, filed on Jun. 14, 2023, which is incorporated herein by reference in its entirety for all purposes.

### TECHNICAL FIELD

This disclosure generally relates to data mining and predictive analysis, and more specifically to keyword assignment and predictive intelligence modeling.

### BACKGROUND

Computing systems currently have limited capabilities to analyze user behavior based on online interactions and predict user engagement and behavior. In some instances, systems will analyze the amount of time a viewer spends watching a video, the search terms a user enters into a search engine, or a user's past purchase history in order to serve additional videos, provide search results, or suggest a new product. Some of these mechanisms are limited to working within a particular provider's walled garden. For example, a purchase history at company A's property will allow company A to suggest subsequent products. Extensive viewing of particular videos at company B's property will allow company B to provide additional videos having similar content. All of these mechanisms are limited in their ability to use outside information or to provide outside entities with information. They further limit the ability to allow for predictive intelligence modeling, both inside and outside of a particular platform.

Mechanisms for managing privacy, abiding by governmental regulations, and tracking real time, current intentions of users also remain extremely limited.

### BRIEF DESCRIPTION OF THE DRAWINGS

FIG. 1 illustrates an example of a system in accordance with various embodiments.

FIG. 2 illustrates another example of a system in accordance with various embodiments.

FIG. 3 illustrates an example of data processing and scraping in accordance with various embodiments.

FIG. 4 illustrates an example of segment processing in accordance with various embodiments.

FIG. 5 illustrates an example of a priority calculation in accordance with some embodiments.

FIG. 6 illustrates an example of device identification and keyword assignment, configured in accordance with some embodiments.

FIG. 7A illustrates an example of implementations, configured in accordance with some embodiments.

FIG. 7B illustrates another example of implementations, configured in accordance with some embodiments.

FIG. 8 illustrates one example of a computing device.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Various embodiments disclosed herein provide the ability to identify devices and enable the providing of web content to such devices based on estimations of such devices' online behavior. More specifically, embodiments disclosed herein retrieve data associated with such devices and generate keyword and probability assignments for such devices. As will be discussed in greater detail below, such keyword and probability assignments may be used to formulate a prediction or estimation of a next action taken by a device. Accordingly, such predictions and estimations may be used to provide relevant web content to the device prior to such actions and in anticipation of such actions. In this way, a user associated with such a device may be provided with relevant web content specifically tailored to that user's particular navigation path on a particular website.

According to various embodiments, a keyword assignment model provided is a predictive intelligence mechanism that ingests user online data such as weblog data. Weblog data may include the number of user visits, visit duration, the number of page views, types of content accessed, entry and exit pages, file types, operating system used, browser used, keywords searched to find a website, as well as phrases searched within a website. In particular embodiments, the predictive intelligence model stack ranks user identifiers (IDs) and page uniform resource locators (URLs) by relevance for specific keywords. According to various embodiments, URLs are scraped for content and stack ranked according to specific keywords through a coordinates-based embedding system. This predictive intelligence model can create high-intent, in-market audiences for specific keywords corresponding to active users IDs. In particular embodiments, keywords may be assigned on many dimensions, such as: financial, product vs service, travel vs non-travel, jobs vs non-jobs, etc., with coordinates that may vary from 0 to 1.

According to various embodiments, the predictive intelligence model system updates, refreshes, and optimizes user analysis data continuously, e.g. on an hourly basis, depending on user activities, creating an innovative online behavior predictive model that works on close-to-real-time user weblog data. The techniques of the present invention recognize significant benefits to continuously evaluating user behavior. In particular embodiments, the predictive intelligence model is also the first keyword-based audience categorization model that enables flexible data taxonomies and hourly data. According to various embodiments, the predictive intelligence model continuously assigns the highest probability keyword or keywords to multiple active users in order to anticipate behavior and match users potentially with entities that have selected those keywords as identifying users of interest. In particular embodiments, the predictive intelligence model is assigning the highest probability keywords that may correspond to content, services, products, solutions, or outcomes that the user may be consciously or subconsciously looking for at that particular moment in time.

In many examples, the predictive intelligence model further predicts future actions and behavior online by keyword road mapping to verify, validate, and potentially monetize existing probability keywords and additional predictions. The predictive intelligence model may use machine learning to analyze millions of examples of user behavior across numerous dimensions to identify additional activities the user may need to perform or additional information that the user may need to obtain. In some examples, high probability keywords identified for particular URLs are matched with corresponding high probability keywords as well as predicted road mapping keywords for particular users. Those particular users may be provided content, video clips, advertising, information, and offers associated with those particular URLs. High probability keywords and predicted road mapping keywords, or keywords associated with the users anticipated next set of actions, may be continuously updated.

In particular embodiments, the predictive intelligence model takes user activity data across one or more devices and stack ranks those user IDs by those keywords based on which pages they visit, taking into account the entire web journey of each user in order to stack rank them by relevant keywords, trying to predict what page URLs they will visit and what products, information, solutions, or services they may be interested in

In some embodiments, a score such as a credit worthiness score is assigned to the user. A credit worthiness score can be determined based upon various factors including, for example, device characteristics. For example, a device that is worth $100 may indicate that the user has a low income level and credit worthiness while a device that is worth $600 may indicate that the user has a high income level and credit worthiness. In addition, the credit worthiness score may be determined based upon information including user weblog data such as that indicating queries submitted by the user, URLs the user is visiting and/or URLs the user is predicted to visit. For example, the syllable count in queries submitted by the user may indicate the intellectual capacity and credit worthiness of the user. As another example, if the user visits a financial site, this may indicate that the user is financially literate and therefore has a high credit worthiness.

In some implementations, the credit worthiness score is determined based upon information including one or more keywords assigned to a user. In addition, one or more dimensions (e.g., between 0 and 1) may be associated with the keywords.

Based, at least in part, on the credit worthiness score, content may be provided to the user via their device. In some implementations, users may be stack ranked according to their credit worthiness score. Based upon the ranking, content may be transmitted to at least some of the users. For example, a set of content may be transmitted to users having high credit worthiness scores. Transmission of content may be accomplished via electronic mail (email), text, or other suitable mechanism.

WebPQ is a branched machine learning model that leverages the ReverseAds keyword assignment algorithm technology to scrape the content of web pages and applications and apply a coordinates-based system to collocate them in a multi-dimensional space of N dimensions, where N is the number of categories it analyzes to understand the context of that page (for example: essay content vs job listing content, educational content vs promotional content, etc.). Through this system, it is possible to analyze the web journey of each user, as well as the frequency and recency of each online interaction.

The algorithm then qualifies and ranks users based on several parameters, such as financial literacy, credit worthiness, credit score, income level, and implied intellectual capacity (e.g., evaluating the syllable count and N-gram word combinations).

Uniquely, WebPQ also takes into account deterministic data extracted from the users' devices into qualification and stack ranking methodology, such as device model, device age and device price range.

As a last step, the pre-qualified users are categorized and clustered based on the advertisers selected parameters and the resulting audience segment can be pushed to third-party platforms such as social media platforms, demand side platforms and data management platforms for activation in digital marketing campaigns.

WebPQ predictive intelligence model allows marketers to perform financial or credit pre-qualification of online users before reaching them through their marketing efforts. This methodology does not replace traditional qualification systems that happen after the user shares their personal data, as it functions as a pre-qualification tool.

Prequalifying users before serving them ads or other types of messaging greatly helps reduce marketing wastage and processing costs from non-qualified applications by refining and reducing the overall population of prospects and potential customers.

A key benefit of this model consists of the capability for marketers to seamlessly integrate the algorithm on the vast majority of advertising platforms for increased marketing efficacy and efficiency. For example, through an API Integration with LinkedIn Ads, it is possible to upload WebPQ Audiences on LinkedIn campaigns to target users who hold specific job titles only above pre-determined salary thresholds.

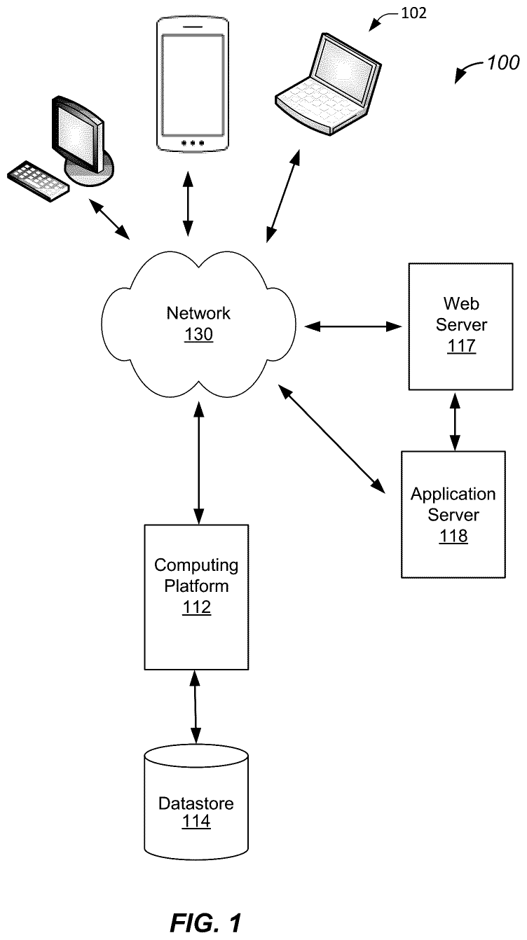

FIG. 1 illustrates a diagram of an example of a system for device identification and keyword assignment, configured in accordance with some embodiments. As discussed above, users may use various devices, such as mobile communications devices, to interact with webpages and elements within webpages, as may occur as a user navigates a hierarchy of a webpage, or proceeds along a decision path of a webpage. As will be discussed in greater detail below, systems disclosed herein, such as system 100, may be configured to identify such devices and generate estimations and predictions of their behavior to facilitate the delivery of web content to the users in a predictive manner.

In this way, devices may be identified, and content may be provided to them efficiently and intelligently as they progress through a decision path of a webpage.

System 100 may include various client machines, which may also be referred to herein as client devices, such as client machine 102. In various implementations, client machine 102 is a computing device accessible by a user. For example, client machine 102 may be a desktop computer, a laptop computer, a mobile computing device such as a smartphone, or any other suitable computing device. Accordingly, client machine 102 includes one or more input and display devices, and is communicatively coupled to communications network 130, such as the internet. In various implementations, client machine 102 comprises one or more processors configured to execute one or more applications that may utilize a user interface. Accordingly, a user may request and view various different display screens associated with such applications via client machine 102. In various implementations, a user interface may be used to present the display screen to the user, as well as receive one or more inputs from the user. In some implementations, client machine 102 may be used to implement a web browser or a standalone locally executed application. Accordingly, users may use client machine 102 to interact with webpages, and click on data objects included in webpages.

System 100 further includes web server 117 which may be configured to serve webpages to various client machines, such as client machine 102. Accordingly, web server 117 is configured to support one or more communications protocols to handle queries from client machine 102 and to obtain and serve web content to client machine 102. For example, such web content may be one or more webpages that each include various data objects displayed to the user as the user interacts with and navigates a webpage. In some embodiments, system 100 also includes application server 118 that is configured to provide content that may be served to client machine 102 via network 130. For example, application server 118 may provide one or more data objects, such as interactive images, videos, or other data objects, that may be included in a webpage provided to a user via client machine 102. In various embodiments, such data objects may convey various information related to one or more actions the user is taking, such as clicking on a button of a webpage or entering information in a data field. The data objects may also convey information associated with a type of webpage that is being viewed by the user, such as a sports webpage or a shopping webpage. While FIG. 1 illustrates one application server 118 and web server 117, it will be appreciated that system 100 may include any number of web servers and application servers.

System 100 may additionally include computing platform 112 that is configured to identify devices, such as client machine 102, and additionally, to intelligently predict behavior of such devices as users associated with the devices progress through decision paths of the webpage. As will be discussed in greater detail below, computing platform 112 may be configured to identify devices using device identifiers, and also to assign such devices keywords and associated probabilities. Accordingly, the stored keywords and probabilities determined for a particular device may identify one or more aspects of a next action taken by the user of the device, as well as a probability of such a next action occurring. In some embodiments, the keyword may be used to identify a type of next action, and may also be used to identify a data object to be provided to the user in anticipation of that next action.

Moreover, as will be discussed in greater detail below, such device identification may be implemented in the context of secure computing environments where action histories or previous data events might not be available. For example, a user may have been interacting with a webpage in a secure computing environment other than computing platform 112, and such interactions might not be visible to computing platform 112. In various embodiments, computing platform 112 may detect the user and associated client machine leaving that secure computing environment, by for example, switching applications or browsers, and may use additional aggregated data to compensate, at least in part, for the inaccessible interaction data retained in the secure computing environment. Additional details regarding computing platforms are discussed in greater detail below. System 100 further includes datastore 114 that may store data associated with computing platform 112. Accordingly, datastore 114 may be a database system or a distributed file storage system that may be included within computing platform 112 or may be implemented separately.

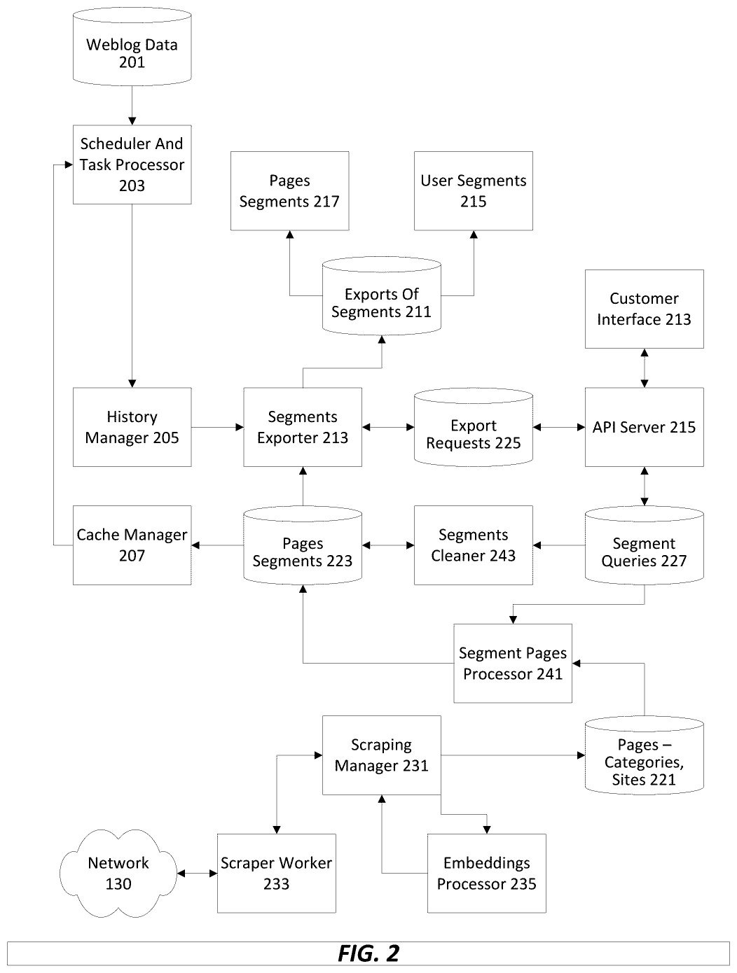

FIG. 2 illustrates an example of a system for keyword assignment predictive intelligence modeling in accordance with various embodiments. According to various implementations, web content such as weblog data 201 is obtained regularly by a scheduler and task processor 203. Weblog data may include all data generated by a web server as a result of interactions with visitors to the website. Weblog data may include user identifiers, IP addresses, time stamps, access requests, amount of data transferred, URL that referred the request, device type, algorithms used, as well as additional parameters associated with the visitor or device. In particular embodiments, weblog data 201 is obtained hourly by the scheduler and task processor 203. The scheduler and task processor 203 may include a history scheduler and one or more history processors. The scheduler and task processor 203 checks for new files and schedules them for processing, processes history files, and collects user identifiers for active segments. In particular embodiments, keywords or groups or keywords and associated parameters are referred to herein as segments.

In some embodiments, a credit worthiness score may be represented via one or more keywords. In addition, a credit worthiness score may be represented by dimension(s) (e.g., between 0 and 1) associated with the keywords. In some embodiments, credit worthiness scores or groups of credit worthiness scores are referred to herein as score segments.

According to various embodiments, the scheduler and task processor 203 checks if URLs are available in cache associated with a cache manager 207. If URLs are not available in cache associated with a cache manager 207, the scheduler and task processor sends those URLs not found in cache to a scraping manager 231. According to various embodiments, the keyword and predictive intelligence model takes weblog data of users' devices and stack ranks those user IDs by those keywords based on which pages visited. A machine learning model takes into account the entire web journey of each user in order to stack rank them by relevant keywords and/or credit worthiness scores, trying to predict what page URLs they will visit and what information, solutions, products, or services they will be in-market for next.

According to various embodiments, the scraping manager 231 is associated with multiple scraper workers 233 that have access to a network 130 such as the Internet. A scraping manager 231 may orchestrate all aspects of the scraping process including checking if a page was already scraped in a pages, categories, and sites database 221. If the page has not already been scraped or has not been recently scraped based on a time period threshold, the scraping manager 231 sends URLs to be scraped to the scraper workers 233. The scraper workers 233 parse and scrape webpages to extract text from them. The scraped pages and scraping results are sent back to the scraping manager 231. In particular embodiments, the scraping manager 231 is also connected to one or more embeddings processors 235. According to various embodiments, the embeddings processors 235 compute embeddings for texts from webpages. Computed embeddings may be sent back as results to scraping manager 231.

In particular embodiments, the scraping manager 231 sends scraped pages and their embeddings to the pages, categories, and sites database 221 for storage and use by a segment pages processor 241, which periodically checks new pages and determines if they fit into any active segment. According to various embodiments, the model scrapes the content of web pages on the Internet and stack ranks them according to specific keywords through a coordinates-based embedding system. Keywords may be assigned to webpages with one or more dimensions. In particular embodiments, coordinates associated with the dimensions may vary from 0 to 1.

The segment pages processor 241 is connected to a segment queries database 227 that is configured to hold current campaigns or segments and their keywords or queries. The segment queries database 227 may also hold parameters for segment. According to various embodiments, segments correspond to keywords and parameters such as threshold, size limitations, user time-to-live, user time-to-idle, etc. In particular embodiments, segments are associated with specific keywords or phrases. Segments and segment queries may be obtained through an API Server 215 connected to a customer interface 213. According to various embodiments, the customer interface 213 may be a search or reverse search platform allowing entities to connect with users having the same input segments or keywords or search terms. In some examples, user keywords may be determined after processing weblog data in order to match users with content of interest such as news, marketing, advertising, and product and service offers, information, bulletins, etc.

In particular embodiments, the segment pages processor 241 periodically checks new pages and determines if they fit any active segment by connecting to the segment queries database 227. The segments pages processor 241 provides pages segments to pages segments database 223. According to various embodiments, the cache manager 207 identifies pages which belong to active campaigns and deserve to be placed in cache from the pages segments database 223. In particular embodiments, the cache manager 207 periodically updates cache and fills it with the most relevant pages from active segments. The pages segments database 223 is also connected to segments exporter 213. The segments exporter 213 requests to export segments in a specified format. The segments exporter 213 also receives user segments from a history manager 205 as well as a pages segments database 223.

A history manager 205 may process history files, collect user identifiers for active segments, and determine if URLs are available. In particular embodiments, the segments exporter 213 exports segments to segments database 211, that provides pages segments 217 and user segments 215.

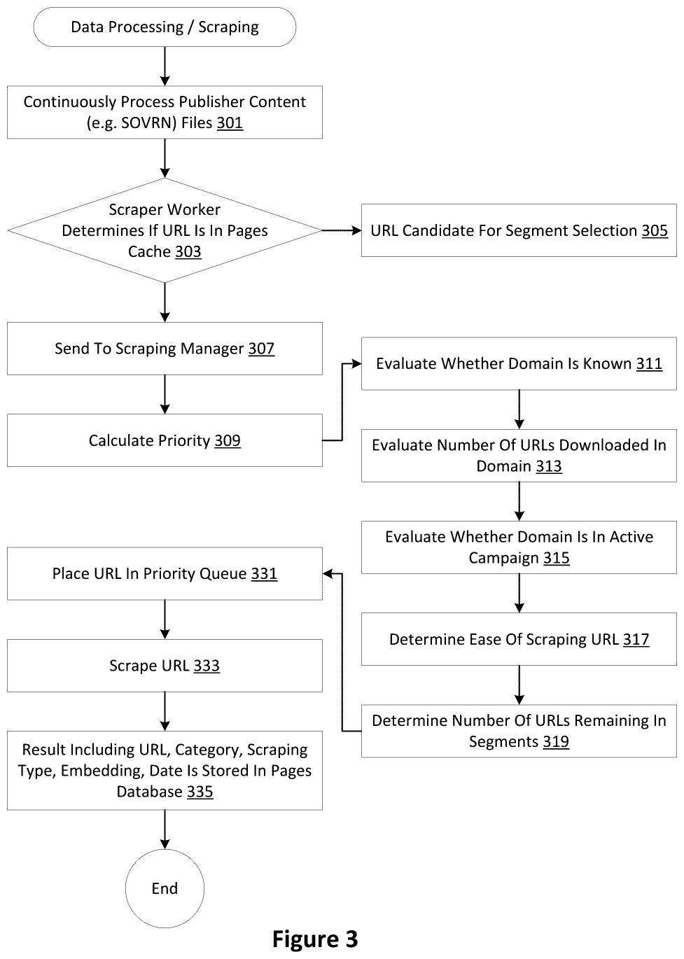

FIG. 3 illustrates an example of data processing and scraping in accordance with various embodiments. In particular embodiments, publisher content is continuously processed at 301. In some examples, thousands of Sovrn files are processed each hour. Tasks may be handled by a queue that sends them to scraper workers. At 303, a scraper worker determines if a particular URL is in pages cache 303. If the URL is in pages cache, the URL is a candidate for segment selection at 305. If the URL is not in pages cache at 303, the URL is sent to a scraping manager 307. According to various embodiments, the URL is sent to a scraping manager with a Sovrn category where it is excluded if it was downloaded before. At 309, priority is calculated by applying multiple factors. In particular embodiments, the URL is parsed and evaluated to determine whether the domain is known at 311. This may involve accessing cache or storage. At 313, the number of URLs downloaded in the domain is evaluated. In particular embodiments, the number of URLs downloaded in the category is also determined.

At 315, it is determined if the domain is in an active campaign. At 317, the difficulty of scraping the URL is determined. The number of URLs remaining in segments is determined at 319.

According to various embodiments, the URL is placed in a priority queue 331. At 333, the content associated with the URL is scraped at 333. In some examples, failed URLs are stored for further analysis while successful URLs are sent for embedding calculations. At 335, the result including the URL, category, scraping type, embedding, date, etc., is stored in the pages database 335.

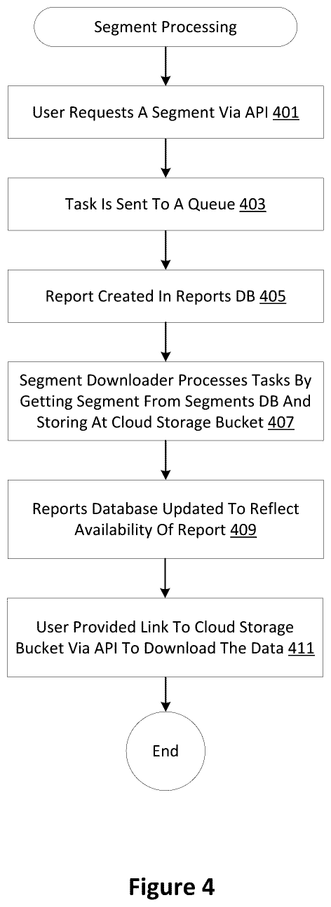

FIG. 4 illustrates an example of segment processing in accordance with various embodiments. According to various embodiments, a user requests a segment via an API at 401. The user may be a person or entity seeking to find content consumers, advertising targets, interest group participants, clients for a particular service, or just generally individuals or entities that the user may wish to engage with. A segment may be associated with one or more keywords as well as parameters corresponding to the one or more keywords. Parameters may include threshold, size limitations, user time-to-live, user time-to-idle, etc. The task is sent to a queue at 403. According to various embodiments, a report is created in a reports database at 405. In particular embodiments, the segment downloader processes the task and other tasks by obtaining the segment from a segments database and storing the segment at a cloud storage bucket at 407. At 409, a reports database is updated to reflect availability of the report.

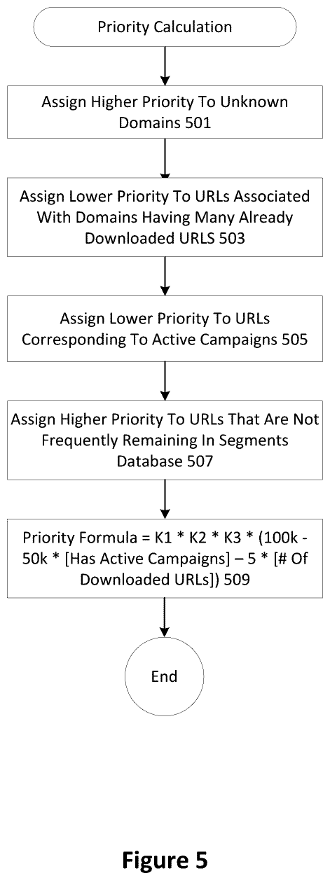

FIG. 5 illustrates an example of a priority calculation in accordance with some embodiments. According to various embodiments, a higher priority is assigned to unknown domains at 501. Unknown domains will be scraped sooner. At 503, a lower priority is assigned to URLs associated with domain having many already downloaded URLs. According to various embodiments, lower priority is assigned to URLs corresponding to active campaigns at 505. According to various embodiments, higher priority is assigned to URLs that are not frequently remaining in a segments database 507. According to various embodiments, the priority formula at 509 is K1*K2*K3*(100k−50k*[Has Active Campaigns]−5*[#Of Downloaded URLs]) 509. In particular embodiments, K1=scraping value, where 5 is regular, 3 is proxy, and 1 is cloud platform or cloudflare. K2=average segment filling=1−Fill/10, e.g. 50%=1−0.5 =0.5. K3=URL type, where 4 is path, 1.5 is URL, and 1 is domain. For unknown domains, the value may be set as 5*1*K3*100K.

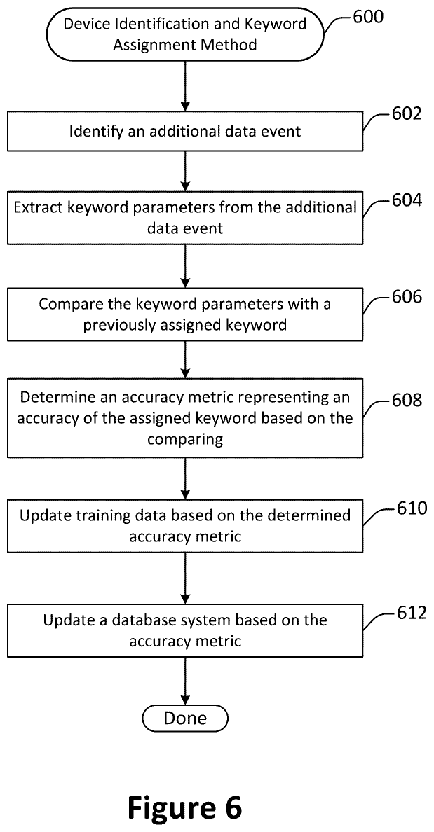

FIG. 6 illustrates a flow chart of an additional example of a method for device identification and keyword assignment, configured in accordance with some embodiments. As similarly discussed above, data events associated with devices may be aggregated and used to generate predictive keywords and probability metrics for those devices. As will be discussed in greater detail below, methods disclosed herein, such as method 600, may be used to implement validation operations to increase the accuracy of device behavior prediction.

Accordingly, method 600 may commence with operation 602 during which an additional data event may be identified. As similarly discussed above, an additional data event may be received subsequent to an initial assignment of a keyword to a particular device identifier associated with a client machine. In some implementations, the keyword can have an associated dimension (e.g., coordinate from 0 to 1) that indicates a presence or absence of a characteristic. More specifically, a user associated with a client machine may take another action and interact with another webpage. The interaction may be logged as a data event and received at a data source, such as a third-party data provider. The additional data event may then be converted to a structured data object and stored in a datastore.

Method 600 may proceed to operation 604 during which keyword parameters may be extracted from the additional data event. As noted above, the additional data event may be converted to a structured data object, and one or more keywords may be extracted from the structured data object. In this way, one or more keywords may be identified for the additional data event, and the one or more keywords may be stored as keyword parameters.

Method 600 may proceed to operation 606 during which the keyword parameters may be compared with a previously assigned keyword. Accordingly, the keyword parameters may be compared with the previously assigned keyword to see if the keywords match. As similarly discussed above, assigned keywords may be compared against a keyword included in the additional data event, and it may be determined if they match. As will be discussed in greater detail below, one or more accuracy metrics may be generated based on the result of the comparison, as well as the identification of one or more types of errors, as discussed above.

Method 600 may proceed to operation 608 during which an accuracy metric may be determined. In various embodiments, the accuracy metric represents an accuracy of the previously assigned keyword. As similarly discussed above, the accuracy metric may be s a similarity score generated based on a determination of an amount of similarity between the previously assigned keyword and the new keyword parameters. Accordingly, semantic or natural language processing techniques may be implemented to characterize a similarly between one or more new keywords and one or more assigned keywords. In some embodiments, the similarity score may be a numerical score or may be some other indicator, such as a flag.

Method 600 may proceed to operation 610 during which training data may be updated. As discussed above, training data associated with one or more machine learning algorithms may be updated by being fed the most recent results. As also discussed above, such training data may be stored in the context of a distributed file system, and the updating of the training data may modify or adjust the one or more machine learning algorithms to ensure the determination of probability metrics is implemented based on the most recent and accurate data.

Method 600 may proceed to operation 612 during which a database system may be updated. Accordingly, a data storage system of the computing platform may be update to store the newly updated training data, the accuracy metric, as well as any updates made to the assigned keyword for the client machine associated with the additional data event. It will be appreciated that method 600 may be implemented periodically such that assigned keywords are periodically and automatically updated. In some embodiments, method 600 may be implemented responsive to one or more conditions, such as detection of a data ingestion event. Accordingly, method 600 may be triggered when new data is received from a data source.

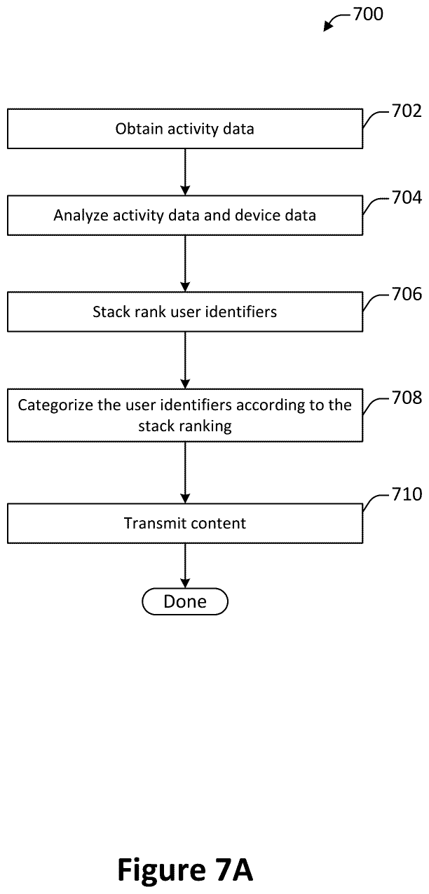

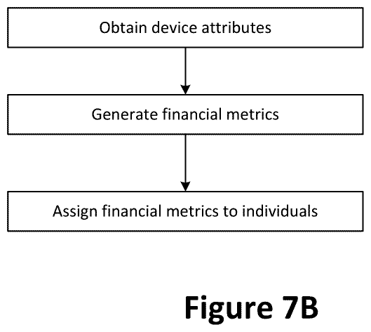

FIG. 7A illustrates an example of implementations, configured in accordance with some embodiments. The system obtains activity data including weblog data of a plurality of user devices corresponding to a plurality of user identifiers at 702, where the weblog data is obtained from a plurality of sources including a plurality of web servers. The weblog data indicates the specific web journey of a user, as well as the recency and frequency of each online interaction.

Device data can be obtained from a packet transmitted by the user's device or, alternatively, may be obtained from a data source. In some instances, a device may be queried for its device data. Therefore, the device data associated with users may be obtained via physical interfaces of the respective devices or from various data sources.

In some implementations, a device manufacturer and/or model is obtained. Based upon the manufacturer and device model, it is possible to determine or approximate an approximate device age and price range. For example, the device model may be searched in a table that maps device models and/or brands to device age and price range. From the price range, it is possible to determine a user's financial ability or credit worthiness.

In some implementations, the activity data and device data associated with the plurality of user devices may be analyzed to assign credit worthiness scores to the user devices or associated users. In some implementations, the activity data and device data associated with the plurality of user devices are analyzed to generate a set of user identifier keywords for each of the user devices at 704. More particularly, the device data includes information pertaining to a user device, and includes information such as device manufacturer, device model, device age, and/or device price range. A device of a higher price range (e.g., 600-800 dollars) or newer model may indicate that the user has a higher income or higher credit worthiness while a device of an older device model or lower priced device may indicate a lower income or lower credit worthiness.

Analysis of the activity data can include various processes for determining credit worthiness. For example, user search queries or other weblog data may be evaluated for syllable count and/or N gram word combinations. An average syllable count over a period of time that exceeds a threshold value may indicate greater intellectual capacity of the user while a lower average syllable count may indicate a lower intellectual capacity.

In some implementations, keywords that are assigned to an individual user can include a keyword indicating a level of intellectual capacity and/or financial literacy of the user. For example, the keyword can include “high,” “low,” “high intellectual capacity,” or “low intellectual capacity,” In specific implementations, intellectual capacity may be expressed via a dimension that is between 0 and 1. For example, intellectual capacity of 0.1 may indicate a low intellectual capacity and intellectual capacity of 0.9 may indicate a high intellectual capacity. An individual of lower intellectual capacity may be assumed to have a lower credit worthiness while an individual of higher intellectual capacity may be assumed to have a higher credit worthiness.

Similarly, a keyword may indicate an income level and/or credit worthiness. In addition, a keyword indicating an income level and/or credit worthiness may have an associated dimension between 0 and 1.

The user identifiers may be stack ranked according to the corresponding credit worthiness scores or sets of user identifier keywords (and optionally, dimensions) at 706, wherein the activity data is continuously analyzed to update the stack ranking of the user identifiers. The plurality of user identifiers may be categorized at 708 according to the stack ranking such that at least a subset of the plurality of user identifiers are assigned to one or more categories. For example, a category of credit worthy users may be identified.

Content may then be transmitted at 710 to devices associated with the subset of the plurality of user identifiers assigned to the categories. For example, content may be transmitted to users determined to have a high income level (e.g., based upon device characteristics and characteristics of content consumed) and high credit worthiness. Transmission of content can include text messages, email messages, or other types of communications.

FIG. 7B illustrates another example of implementations, configured in accordance with some embodiments. Data indicating device attributes associated with a plurality of devices is collected from one or more data sources at 720, where the device attributes include one or more of: device model, device manufacturer, device age, and/or device price. Financial capacity metrics for individuals associated with the plurality of devices are generated based, at least in part, on the data at 722. For example, based upon information in a table, it may be concluded that devices that are above $600 are owned by individuals having a higher financial capacity and devices that are less than $600 are owned by individuals having a lower financial capacity. The financial capacity metrics are then assigned to the individuals at 724. The financial capacity metrics may then be applied to select content to transmit to the individuals.

In some implementations, activity data is collected, where the activity data includes weblog data of a plurality of user devices corresponding to a plurality of user identifiers, the weblog data obtained from a plurality of sources including a plurality of web servers. The financial capacity metrics may be further generated at 722 based, in part, on the activity data. More particularly, the activity data may be analyzed to determine personal characteristics such as financial literacy, intellectual capacity, hobbies, habits, etc. These personal characteristics may be used to determine financial capacity, either alone or in combination with device characteristics.

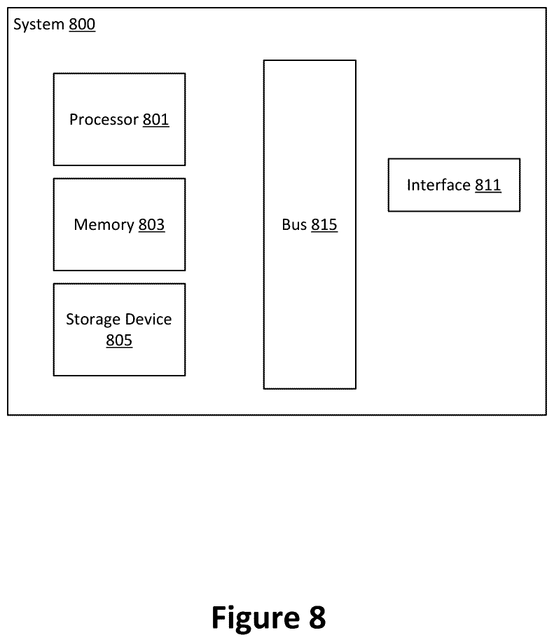

FIG. 8 illustrates one example of a computing device, configured in accordance with some embodiments. According to various embodiments, system 800 suitable for implementing embodiments described herein includes a processor 801, a memory module 803, a storage device 805, an interface 811, and a bus 815 (e.g., a PCI bus or other interconnection fabric.) System 800 may operate as variety of devices such as an application server, a web server, or any other device or service described herein. Although a particular configuration is described, a variety of alternative configurations are possible. The processor 801 may perform operations such as those described herein. Instructions for performing such operations may be embodied in the memory 803, on one or more non-transitory computer readable media, or on some other storage device. Various specially configured devices can also be used in place of or in addition to the processor 801. The interface 811 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some implementations include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities. Accordingly, Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method, comprising:
obtaining activity data including weblog data of a plurality of user devices corresponding to a plurality of user identifiers, the weblog data obtained from a plurality of sources including a plurality of web servers;
obtaining device data associated with the plurality of user devices;
analyzing the activity data and device data associated with the plurality of user devices to generate a set of user identifier keywords for each of the user devices;
stack ranking the plurality of user identifiers according to the corresponding sets of user identifier keywords, wherein the activity data is continuously analyzed to update the stack ranking of the user identifiers; and
categorizing the plurality of user identifiers according to the stack ranking such that at least a subset of the plurality of user identifiers are assigned to one or more categories.

2. The method of claim 1, further comprising:
collecting the device data from one or more data sources;
processing data including the collected device data to generate financial capacity metrics for individuals, wherein the collected device data contributes to an estimation of an individual's financial capacity, the estimation based on the assumption that certain device characteristics correlate with higher financial capacity; and
assigning financial capacity scores to individuals based on an analysis of the device data, thereby providing a proxy measure of their economic standing.

3. The method of claim 1, further comprising:
expanding the evaluation of the device data to include analysis of traffic data from one or more sources to assess personal characteristics such as financial literacy, intellectual complexity, healthy habits, and hobbies;
collecting and processing traffic data to extract patterns and behaviors indicative of these characteristics, wherein interactions with specific types of content are used as indicators of the respective personal characteristic; and
assigning relevance scores to these behaviors based on analysis of the traffic data, thereby constructing a comprehensive profile that reflects an individual's financial literacy, intellectual pursuits, health consciousness, and personal interests to provide a nuanced understanding of their personal character.

4. The method of claim 1, further comprising:
transmitting content to devices associated with the subset of the plurality of user identifiers assigned to the categories.

5. The method of claim 1, each set of user identifier keywords including one or more of: income level keyword, credit worthiness keyword, or intellectual capacity keyword.

6. The method of claim 1, each set of user identifier keywords having one or more dimensions, wherein the plurality of user identifiers are further stack ranked according to the dimensions.

7. The method of claim 1, the device data comprising one or more of: device model, device age, or device price range.

8. The method of claim 1, wherein analyzing the activity data comprises:
evaluating syllable count and N gram word combinations of the weblog data.

9. The method of claim 1, further comprising:
scraping content associated with a plurality of page uniform resource locators (URLs);
analyzing the content to determine a plurality of page URL keywords within the content; and
ranking the plurality of page URLs according to the plurality of page URL keywords.

10. A system comprising:
a processor; and
a memory, the processor being configured to:
obtain activity data including weblog data of a plurality of user devices corresponding to a plurality of user identifiers, the weblog data obtained from a plurality of sources including a plurality of web servers;
obtain device data associated with the plurality of user devices;
analyze the activity data and device data associated with the plurality of user devices to generate a set of user identifier keywords for each of the user devices;
stack rank the plurality of user identifiers according to the corresponding sets of user identifier keywords, wherein the activity data is continuously analyzed to update the stack ranking of the user identifiers;
categorize the plurality of user identifiers according to the stack ranking such that at least a subset of the plurality of user identifiers are assigned to one or more categories; and
transmit content to devices associated with the subset of the plurality of user identifiers assigned to the categories.

11. The system of claim 10, each set of user identifier keywords including one or more of: income level keyword, credit worthiness keyword, or intellectual capacity keyword.

12. The system of claim 11, each set of user identifier keywords having one or more dimensions, wherein the plurality of user identifiers are further stack ranked according to the dimensions.

13. The system of claim 10, the device data comprising one or more of: device model, device age, or device price range.

14. The system of claim 10, wherein analyzing the activity data comprises:
evaluating syllable count and N gram word combinations of the weblog data.

15. A non-transitory computer-readable medium, comprising:
computer code for obtaining activity data including weblog data of a plurality of user devices corresponding to a plurality of user identifiers, the weblog data obtained from a plurality of sources including a plurality of web servers;
computer code for obtaining device data associated with the plurality of user devices;
computer code for analyzing the activity data and device data associated with the plurality of user devices to generate a set of user identifier keywords for each of the user devices;
computer code for stack ranking the plurality of user identifiers according to the corresponding sets of user identifier keywords, wherein the activity data is continuously analyzed to update the stack ranking of the user identifiers;
computer code for categorizing the plurality of user identifiers according to the stack ranking such that at least a subset of the plurality of user identifiers are assigned to one or more categories; and
computer code for transmitting content to devices associated with the subset of the plurality of user identifiers assigned to the categories.

16. The non-transitory computer readable medium of claim 13, each set of user identifier keywords including one or more of: income level keyword, credit worthiness keyword, or intellectual capacity keyword.

17. The non-transitory computer readable medium of claim 14, each set of user identifier keywords having one or more dimensions, wherein the plurality of user identifiers are further stack ranked according to the dimensions.

18. The non-transitory computer readable medium of claim 13, the device data comprising one or more of: device model, device age, or device price range.

19. A method, comprising:
collecting data indicating device attributes associated with a plurality of devices from one or more data sources, the device attributes including one or more of: device model, device manufacturer, or device age;
processing the collected data to generate financial capacity metrics for individuals associated with the plurality of devices; and
assigning the financial capacity metrics to the individuals.

20. The method of claim 19, further comprising:
obtaining activity data including weblog data of a plurality of user devices corresponding to a plurality of user identifiers, the weblog data obtained from a plurality of sources including a plurality of web servers;
wherein generating the financial capacity metrics is further based on the activity data.

21. The method of claim 19, the data sources including at least one database.

22. The method of claim 19, the device attributes including device manufacturer and device model.
